(19) United States
(12) Patent Application Publication
(10) Pub. No.: US 2002/0119697 A1
(43) Pub. Date: Aug. 29, 2002

(54) Mobile phone connector

(76) Inventor: Wen-Yao Chan, Shulin City (TW)

Correspondence Address: Keith Kline, PRO-TECHTOR INTERNATIONAL SERVICES, 20775 Norada Court, Saratoga, CA, 95070-3018, US

(21) Appl. No.: 09/747,834

(22) Filed: Dec. 27, 2000

(51) Int. Cl. H01R 13/52

(52) U.S. Cl. 439/519

(57) ABSTRACT

This invention is a mobile phone connector, a connector with anti-dust and water-resistant functions. The connector comprises: a connector main unit having a welded side and a matching side, and an insulating casing on the outside of the connector main unit, having correspondingly a welded side and a matching side, characterized in that: on the matching side of the insulating casing is a cover unit that is fixed by a shaft. Between the cover unit and the matching side of the insulating casing are an anti-leak washer and a fastening device, so designed that when the cover unit is fixed by the shaft to the insulating casing, the anti-leak washer is pressed tight against the matching side of the insulating casing, so that side is sealed, and meanwhile, the obstruction of the cover unit provides anti-dust and water-resistant effects to the matching side of the insulating casing.

### BACKGROUND OF THE INVENTION

1. Field of the invention

This invention relates to a mobile phone connector, particularly to a mobile phone connector with anti-dust and water-resistant functions.

2. Background of the invention

The performance of mobile phones has advanced from unsophisticated communication to the integration of facsimile and Internet surfing. To maintain stability and best quality of signal transmission to satisfy the requirement of different occasions and environmental conditions, such as in a humid area, it has become a trend to develop mobile phones that are designed to suit specific environmental circumstances. To meet the new development trend of mobile phones, the connectors assembled to the mobile phone for signal transmission must have corresponding measures. Mere emphasis on the casing of mobile phone without attention to the connector will prove to be futile. In the conventional mobile phone, the connector is installed at the edge of the casing, while its matching side is exposed for connection with the power cord. Therefore, before it is connected to a corresponding plug, the exposed connector is subjected to dirt and dust contamination, resulting in poor connection and bad influence to the stability of signal transmission. Therefore, manufacturers used to install a rubber cap on the casing of the mobile phone, to cover the exposed side of the connector. However, that design could not solve many problems, including too much humidity in humid environment that may result in bad effect to the correct contact of signals, or even short-circuit, etc.

### BRIEF DESCRIPTION OF THE INVENTION

1. Objectives of this Invention

The main objective of this invention of mobile phone connector is to provide an anti-dust and water-resistant connector, the connector having anti-dust and water-resistant devices. So that, after it is assembled to a mobile phone, the quality of signal transmission can be ensured.

When such a connector equipped with anti-dust and water-resistant functions is assembled to the housing of a mobile phone that is also designed to resist water, the design of the mobile phone housing can be simplified to have water-resistant performance.

Another objective of this invention of mobile phone connector is to provide convenience and applicability to the user, because the cover unit serves as an anti-dust and water-resistant device for the connector, and enables convenient obstruction or switching-on operation.

2. Characteristics of the Invention

The invention is a mobile phone connector that has anti-dust and water-resistant functions, the connector comprising of: a connector main unit having a welded side and a matching side, and an insulating casing on the outside of the connector main unit, having correspondingly a welded side and a matching side, characterized in that: on the matching side of the insulating casing is a cover unit that is fixed by a shaft; between the cover unit and the matching side of the insulating casing are an anti-leak washer and a fastening device, so designed that when the cover unit is fixed by the shaft to the insulating casing, the anti-leak washer will be pressed tight against the matching side of the insulating casing, so that the matching side is sealed; meanwhile, the obstruction of the cover unit provides anti-dust and water-resistant effects to the matching side of the insulating casing.

Based on the main characteristic as described above, the fastening device comprises fastening posts and a flange that are respectively installed at corresponding positions between the cover unit and the insulating casing.

### BRIEF DESCRIPTION OF DRAWINGS

The drawings of preferred embodiments of this invention are described in details to enable better understanding.

FIGS. 1 and 2 are exploded views of this invention of mobile phone connector from different angles.

FIGS. 3A, 3B and 3C are exploded views of this invention of mobile phone connector as it is partially and completely assembled.

FIG. 4 is a perspective view of FIG. 3C.

FIG. 5 is a section view of FIG. 4 taken from the line marked A-A.

FIG. 6 is a front view of this invention of connector when it is assembled to a mobile phone.

FIG. 7 is a regional section view of FIG. 6 from one side.

FIG. 8 is a close-up view of FIG. 7.

FIGS. 9 and 10 are section views of the front of a region of this invention of connector when it is assembled to a mobile phone.

BRIEF DESCRIPTION OF NUMERALS

| | | | |
|---|---|---|---|
| 1 | connector | 10 | connector main unit |
| 101 | welded side | 102 | matching side |
| 11 | metal obstruction | 110 | snap |
| 12 | conductive terminal unit | 121 | conductive terminal |
| 13 | contact terminal unit | 131 | contact terminal |
| 14 | DC charging unit | 141 | DC charging terminal |
| 20 | insulating casing | 21 | accommodating chamber |
| 22 | joining hole | 23 | depressed groove |
| 24 | fastening post | 201 | welded side |
| 202 | matching side | 210 | fastening groove |
| 30 | cover unit | 31 | shaft |
| 310 | expanded part | 311 | slotted groove |
| 301 | flange | 32 | sealing unit |
| 40 | anti-leak washer | 5 | mobile phone |
| 50 | casing | 60 | anti-leak washer |

### DETAILED DESCRIPTION OF PREFERRED EMBODIMENTS

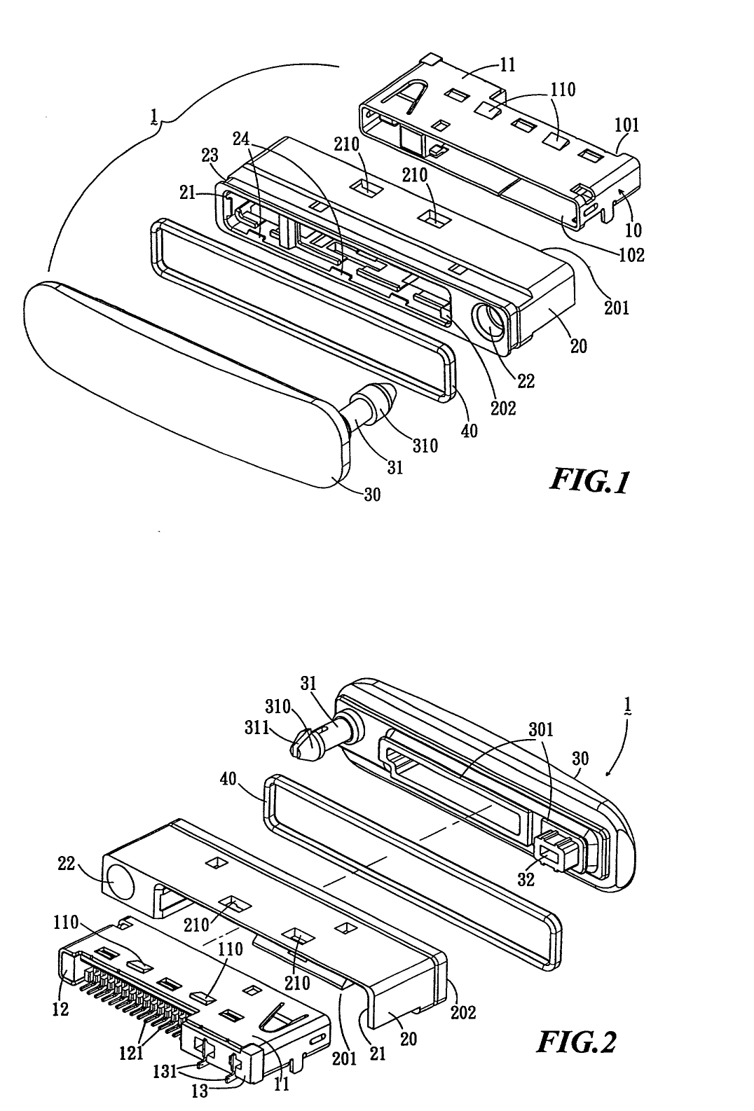

As shown in FIGS. 1 and 2, this invention of connector comprises: a connector main unit 10, an insulating casing 20, a cover unit 30 and an anti-leak washer 40. In which, the connector main unit has a welded side 101 and a matching side 102. As shown in FIG. 4, the connector main unit 10 is composed of a metal obstruction 11, a conductive terminal unit 12, a contact terminal unit 13, and a DC charging unit 14. A conductive terminal 121 is accommodated in the conductive terminal unit 12, for transmission of signals. A contact terminal 131 is accommodated in the contact terminal unit 13. A DC charging terminal 141 is accommodated in the DC charging unit 14. The metal obstruction 11 envelops the conductive terminal unit 12 and the contact terminal unit 13, as well as the DC charging unit 14.

The insulating casing 20 has an accommodating chamber 21 to accommodate the connector main unit 10. On the top of the accommodating chamber 21 are matching fastening grooves 210 that can be fastened with snaps 110 on the metal obstruction 11 of the connector main unit 10. On the insulating casing 20 corresponding to the connector main unit 10 are respectively a welded side 201 and a matching side 202. Next to the accommodating chamber 21 is a joining hole 22 to fit with the cover unit 30. On the outside rim of the matching side 202 is a depressed groove 23 to accommodate the anti-leak washer 40. On the inside rim of the matching side 202 of the accommodating chamber 21 is a fastening post 24 that can be fastened to the flange 301 on the cover unit 30 after the cover unit 30 is closed thereon (shown in FIG. 2).

On one side of the cover unit 30 is a shaft 31 that can be fitted into the joining hole 22 on the insulating casing 20. At the front part of the shaft 31 is an expanded part 310 with an axially aligned slotted groove 311, providing appropriate compressive elasticity to the expanded part 310 and fastening effect when it is fitted to the joining hole 22. The cover unit 30 has a sealing unit 32 that serves to seal the matching groove where the contact terminal is located 131, for better water-resistant effect.

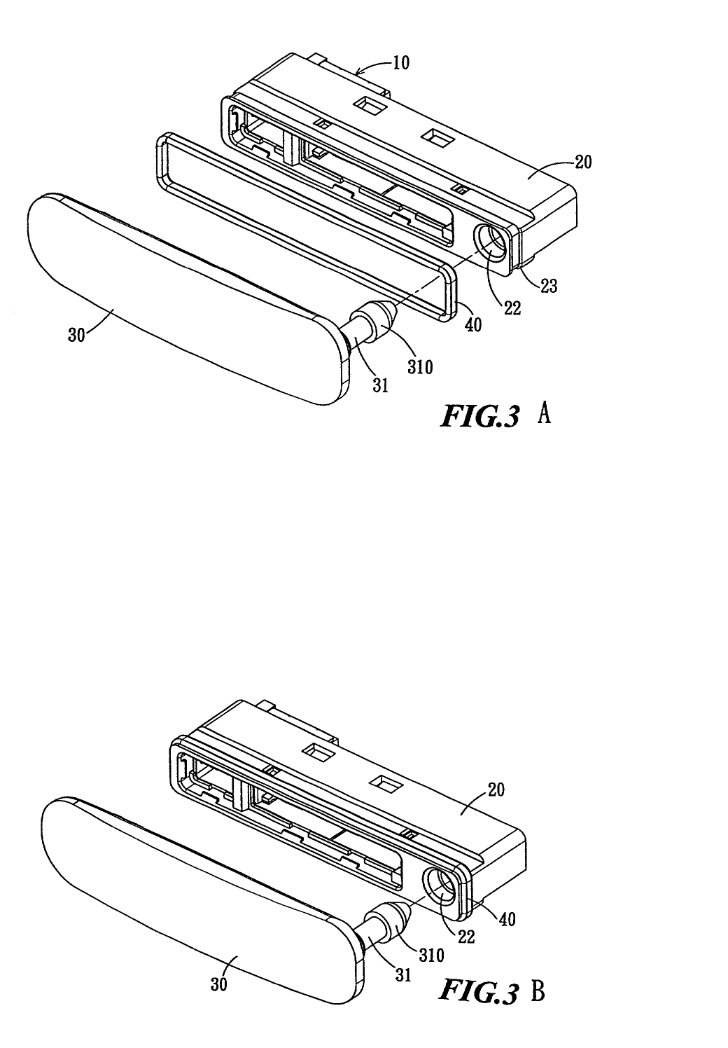

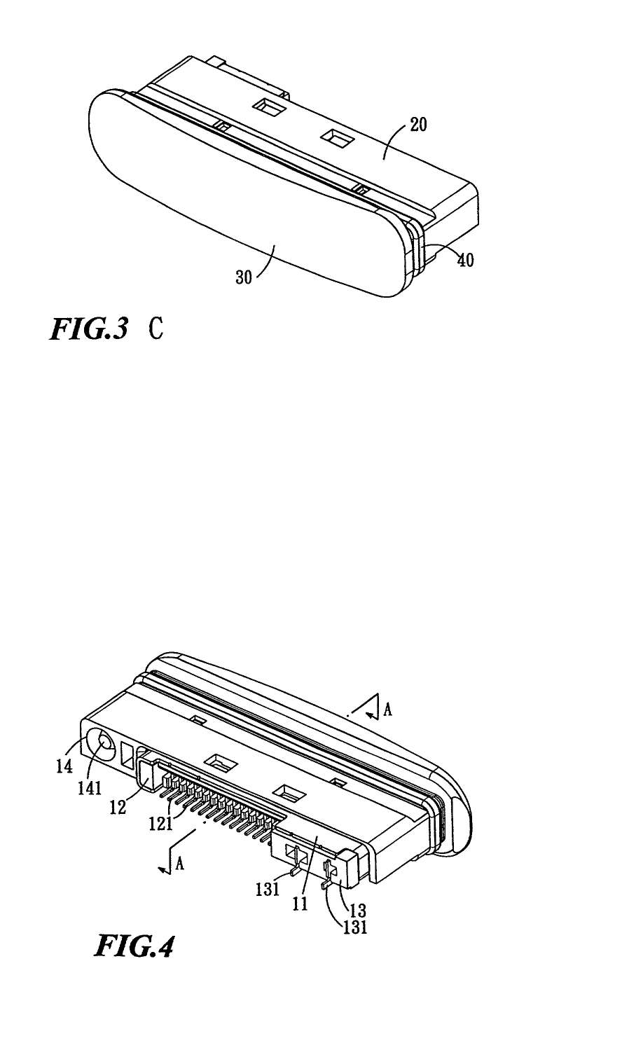

This invention is assembled in a way shown in FIGS. 3A, 3B and 3C. As illustrated in FIG. 3A, the connector main unit 10 is assembled to the accommodating chamber 22 of the insulating casing 20. Then, as shown in FIG. 3B, the anti-leak washer 40 is assembled in the depressed groove 23 of the insulating casing 20. Finally, as shown in FIG. 3C, the shaft 31 of the cover unit 30 is fitted into the joining hole 22 of the insulating casing 20, thus this invention of connector is assembled.

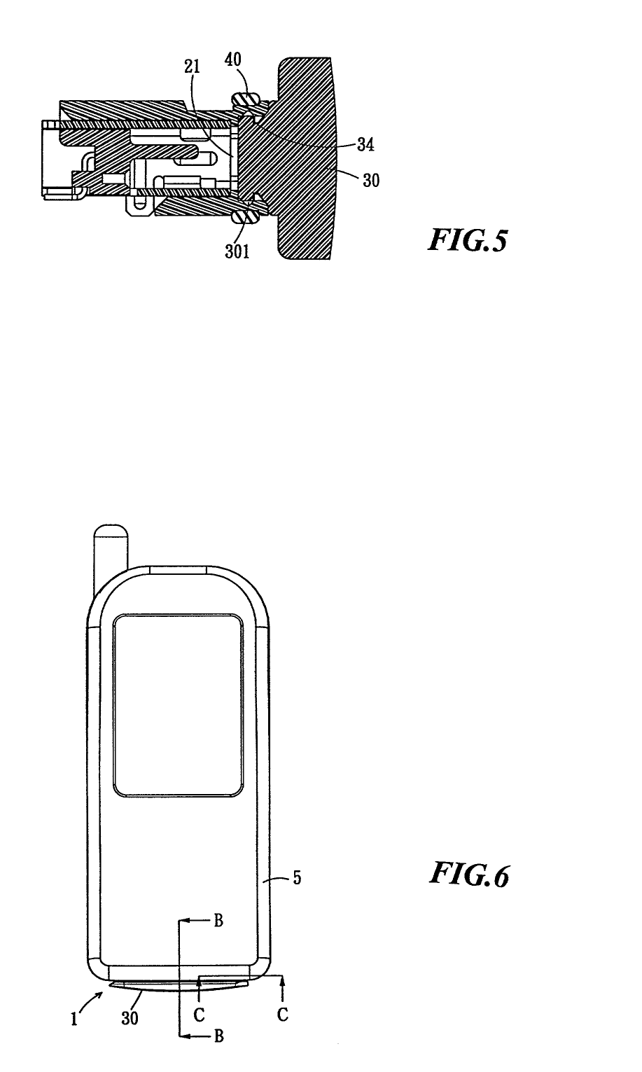

As shown in FIG. 5 that is a section view of FIG. 4 taken from the line marked A-A, after the cover unit 30 has closed the accommodating chamber 21, the flange 301 of the cover unit 30 is fastened by the fastening post 24 of the insulating casing 20, so the accommodating chamber 21 is sealed.

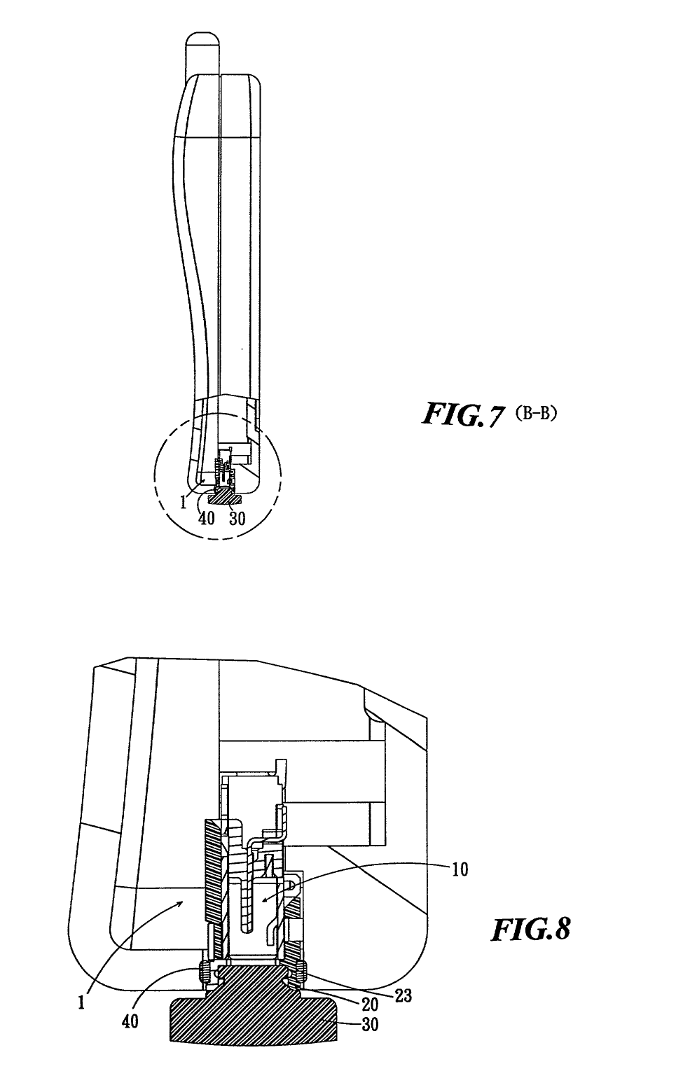

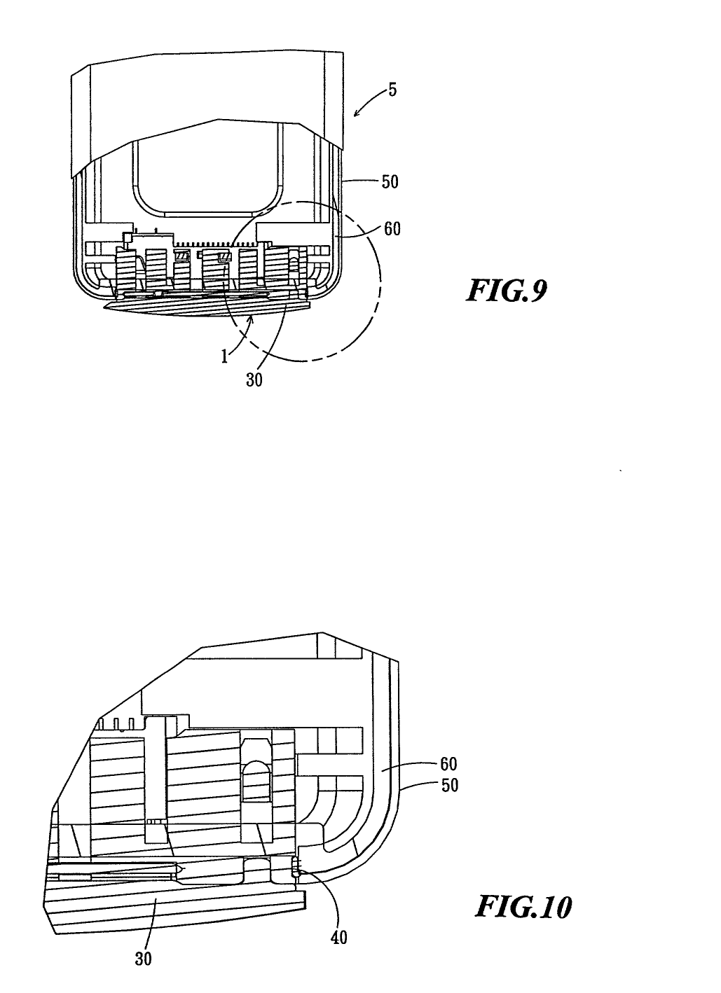

FIGS. 6 through 8 illustrate the preferred embodiment of this invention of connector 1 when it is assembled to a mobile phone 5. As shown in FIG. 6, only the cover unit is exposed 30 after this invention is fully assembled. In FIG. 8, the anti-leak washer 40 inside the depressed groove 23 of the insulating casing 20 serves to prevent water from seeping through the joint seam of the mobile phone 5 into the connector main unit 10, which may influence the transmission of signals. In other words, in addition to anti-dust and water-resistant features of the cover unit 30 on the matching side of the connector main unit 10, this invention has water-resistant function on the joining side of the mobile phone 5. Therefore, this invention is adequately equipped with anti-dust and water-resistant effects when it is assembled to a mobile phone. Of course, as shown in FIGS. 9 and 10, the mobile phone 5 itself is water-resistant, having an anti-leak washer 60 installed between two joining cover units 50.

As evidenced in the above description, this invention is capable of achieving its anticipated objective, which has satisfied the requirement for a patent. It should be declared herewith that the above description covering only the preferred embodiment of this invention could not be based to restrict the scope of application of this invention, and that all modifications or variations made within the scope of the claims shall be included in this patent right.

What is claimed is:

1. A mobile phone connector, that is anti-dust and water-resistant, said connector comprising:
A connector main unit, having a welded side and a matching side, accommodating at least a signal terminal and a contact terminal;
An insulating casing, having an accommodating chamber to accommodate and fix said connector main unit, at corresponding locations on the connector main unit are respectively a welded side and a matching side;
A cover unit, on one side of which is a shaft that is fitted to the matching side of the insulating casing; and a fastening device between the cover unit and the accommodating chamber of the insulating casing.

2. The mobile phone connector claimed in claim 1, wherein said fastening device comprises several fastening posts on the inside rim of the accommodating chamber of the insulating casing, a flange on one side of the cover unit matching the fastening posts, thereby the fastening posts are fastened to the corresponding flange on the cover unit when the cover unit closes the accommodating chamber of the insulating casing, to seal the accommodating chamber tightly.

3. The mobile phone connector claimed in claim 2, wherein on one side of the cover unit opposite the matching side of the insulating casing further has a sealing unit to seal the matching groove where the contact terminal is located.

4. The mobile phone connector claimed in claim 3, wherein the front end of the shaft of the cover unit is formed as an expanded part having an axially aligned slotted groove, providing appropriate compressive elasticity to the expanded part, and compressive effect when it is fitted to the joining hole of the insulating casing.

5. The mobile phone connector claimed in claim 1, wherein on the outside rim of the matching side of the insulating casing is a depressed groove to accommodate an anti-leak washer, serving as an anti-leak device installed between the insulating casing and the housing of the mobile phone.

6. The mobile phone connector claimed in claim 1, wherein on one side of the cover unit opposite the shaft, at the end of the matching side opposite the insulating casing, is an inclined guide face to facilitate manual switching.

7. A mobile phone connector, particularly an anti-dust and water-resistant connector that comprises the following:
A connector main unit, having a welded side and a matching side, containing a conductive terminal unit with a metal obstruction accommodating a conductive terminal, and a contact terminal unit accommodating a contact terminal;
An insulating casing, having an accommodating chamber to accommodate and fix said connector main unit, at corresponding locations on the connector main unit are respectively a welded side and a matching side;

8. The mobile phone connector claimed in claim 7, wherein said fastening device comprises several fastening posts on the inside rim of the accommodating chamber of the insulating casing, a flange on one side of the cover unit matching the fastening posts, thereby the fastening posts are fastened to the corresponding flange on the cover unit when the cover unit closes the accommodating chamber of the insulating casing, to seal the accommodating chamber tightly.

9. The mobile phone connector claimed in claim 8, wherein on one side of the cover unit opposite the matching side of the insulating casing further has a sealing unit to seal the matching groove where the contact terminal is located.

10. The mobile phone connector claimed in claim 7, wherein the front end of the shaft of the cover unit is formed as an expanded part having an axially aligned slotted groove, providing appropriate compressive elasticity to the expanded part, and compressive effect when it is fitted to the joining hole of the insulating casing.

11. The mobile phone connector claimed in claim 10, wherein on the outside rim of the matching side of the insulating casing is a depressed groove to accommodate an anti-leak washer, serving as an anti-leak device installed between the insulating casing and the housing of the mobile phone.

12. The mobile phone connector claimed in claim 7, wherein on one side of the cover unit opposite the shaft, at the end of the matching side opposite the insulating casing, is an inclined guide face to facilitate manual switching.
